(19) United States
(12) Patent Application Publication
(10) Pub. No.: US 2022/0266464 A1
(43) Pub. Date: Aug. 25, 2022

(54) SELF CLEANING RAZOR

(71) Applicants: Erin K. Seferi, Southbury, CT (US); Nicholas L. Seferi, Southbury, CT (US)

(72) Inventors: Erin K. Seferi, Southbury, CT (US); Nicholas L. Seferi, Southbury, CT (US)

(21) Appl. No.: 17/185,951

(22) Filed: Feb. 25, 2021

(51) Int. Cl. B26B 21/40; B26B 21/52

(52) U.S. Cl. CPC B26B 21/4012; B26B 21/52

(57) ABSTRACT

Self-cleaning manual razor equipped with a pair of rollers and a pair of blades arranged in an alternating manner with each other. The rollers move the hair, skin, and cream away from the blades effortlessly during the shaving process. The rollers rotate in unison with respective gears, which in turn rotate in unison because of a counter gear between them rotating in a reverse direction and whose teeth mesh with teeth of the respective gears. The self-cleaning razor may be equipped with a further blade downstream of the other two blades. A shield may be provided in the space between the lead roller and the lead blade. Side shields encase the gears to block the entry of cut hair, skin and cream to the gears.

### CROSS-REFERENCE TO RELATED APPLICATIONS

Not applicable.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### REFERENCE TO A “SEQUENCE LISTING,” A TABLE, OR A COMPUTER PROGRAM LISTING APPENDIX SUBMITTED ON A COMPACT DISC AND AN INCORPORATION-BY-REFERENCE

Not applicable.

### BACKGROUND OF THE INVENTION

### Field of the Invention

The invention relates to a handheld razor equipped with razor cutting blades and suitable for shaving with cream to remove facial hair or other body hair.

### 2. Description of Information Known to the Inventor, Including References to Specific Documents Related to the Invention, and Specific Problems Involved in the State of Technology that the Invention is Drawn Toward

Razor blades inherently clog. The function of cutting hair and moving the hair, skin, and saving cream from one side of the razor to the other creates clogging in the blades. This clogging results in hair being cut multiple times and additional force needed to cut similar amounts of hair. It doesn't matter how many blades are on the razor, clogging will happen. Once the razor is done being used any residual hair, skin, and cream will dry on the blades and will hold moisture on the blades and accelerate dulling.

One of the biggest downsides of using cartridge razors is that the replacement cartridges are expensive. One can end up spending hundreds of dollars a year on replacement cartridges. Typically, companies that supply cartridge razors don't provide any instruction on their packaging on how to store and care for the razor to maximize its longevity, perhaps because doing so would severely cut into their profits.

Nevertheless, the following techniques for preserving the useful life of cartridge razors are set forth online in an article by Benjamin Rose on Feb. 23, 2021 titled “Mach 3 vs. Fusion (Battle of the Best Cartridge Razor!)” at primandprep.com/mach-3-vs-fusion/:
Dry your razor after every use
Water that sits on the blade will corrode them through the process of oxidation (i.e rust) as well as leave mineral deposits that will build up and hinder the blade from smoothly cutting the hair. Simply dry your razor with by either blotting it with a towel or using a blow dryer after every use.
Coat the Razor with Alcohol or Oil
Oxidation that causes the blade to dull and flake is not only caused by water but by air itself. To further protect the blade from such exposure, dip the blade into some form of alcohol (e.g. rubbing alcohol) or an oil (e.g. mineral oil) after drying it.
Store Your Razor in a Dry Place
Your bathroom is the perfect environment for metals to oxidize as it is so commonly humid due to hot showers, etc. I would recommend storing your razor in a plastic bag and placing it within one of your bathroom drawers to prevent the blades from being exposed to a humid climate that is all so prevalent in your bathroom.
Alternate Method
If you really want to take your cartridge razor maintenance to the next level, there is supposedly a very effective method that consists of rubbing your razor across a pair of blue jeans which will preserve and sharpen the blades.

While undertaking such techniques may well extend the useful life of the cartridge razor, more should be done in its design to render the cartridge razor self-cleaning. It is desired to design a self-cleaning razor that eliminates clogging of its razor blades and avoids acceleration of dulling from moisture attributed to residual hair, skin and cream.

### SUMMARY OF THE INVENTION

The present inventor has found that by adding two linked rollers in front of the first two cutting blades of a manual razor, the rollers move the hair, skin, and cream away from the blades effortlessly during the shaving process. Once done, the rollers may be manually engaged to further clear any final debris out away from the blades to prolong the life of the razor.

### BRIEF DESCRIPTION OF THE DRAWING

For a better understanding of the present invention, reference is made to the following description and accompanying drawings, while the scope of the invention is set forth in the appended claims.

FIG. 1 is an isometric view of a top, front and side of a razor in accordance with our invention.

FIG. 2 is a partially exploded, isometric view of the top, front and side of the razor with its cover piece lifted in accordance with our invention.

FIG. 3 is an isometric view of the top, rear and side of the razor in accordance with our invention.

FIG. 4 is a front view of the razor in accordance with our invention.

FIG. 5 is a cross section along a lengthwise centerline of a variation of the razor of FIGS. 1-4.

### DETAILED DESCRIPTION OF THE DRAWING

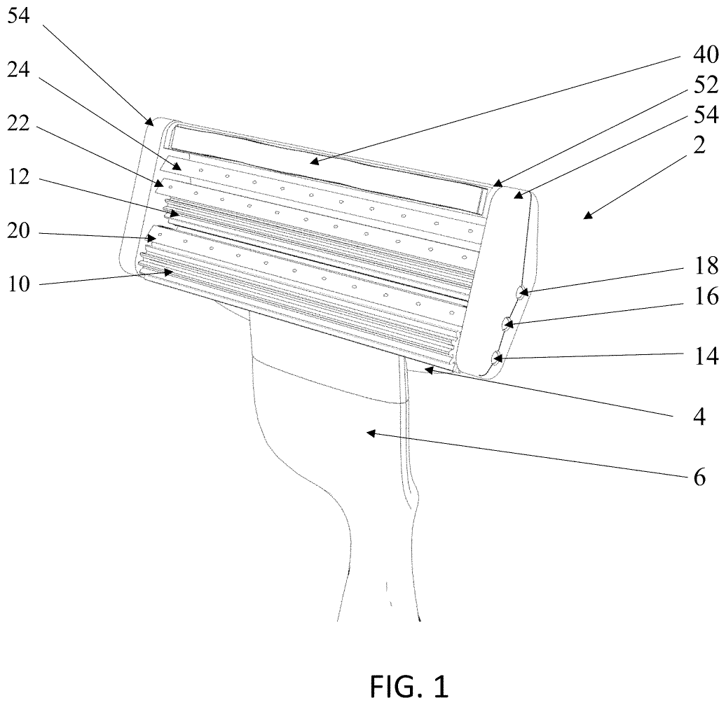

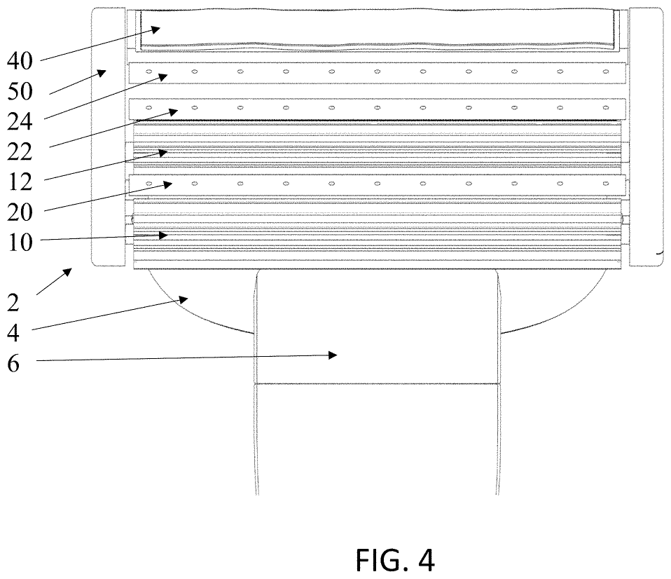

Turning to the drawings of FIGS. 1-4, a razor head or cartridge 2 is shown supported via a winged section 4 by a handle 6. The razor cartridge 2 includes a lead roller 10 that is directly in front of a lead blade 20. There is nothing in front of this lead roller. It makes contact with the skin and begins the rolling action.

This lead roller 10 in front of the lead cutting blade 20 performs the function of moving the initial debris to the back of the razor and clearing a path for more material. (hair, skin, shaving cream).

The lead cutting blade 20 performs the function of doing the rough cut, that is, cutting the bulk of the hair as the lead cutter.

The trailing roller 12 is at the same height as the lead roller 10. It has the same paddles to grip and move hair, skin, and cream away. It is directly in front of the trailing middle cutting blade 22.

This trailing roller 12 performs the function of clearing the debris from in front of the trailing middle blade 22 and continuing the cutting and clearing process.

The trailing middle cutting blade 22 is continuing to cut the hair. Now the hair is cut to about skin level.

The final cutting blade 24 is the final cutter. The two blades (lead blade 20 and trailing middle blade 22) that perform their cutting functions before that of the final cutting blade 24 have done the majority of the work. The lead roller 10 and trailing roller 12 have cleared the debris away; the final cutting blade 24 performs the finishing cut.

A moisturizing strip 40, which is applied to a detachable cover piece 50 in a conventional manner, conditions the skin more effectively since there is a cleaner surface. The detachable cover piece 50 has spaced apart openings 44 that align with openings 42 of an underlying frame bar 52. The openings 44 in the cover piece 50 are on where the moisturizing strip 40 connects in a conventional manner.

The cover piece 50 has a cover bar 53 with four spaced apart openings 44 and has two cover arms 54 that extend outward from opposite ends of the cover bar 53. The razor cartridge 2 has a frame bar 52 with four spaced apart openings 42 and has two frame arms 70 that extend outward from opposite ends of the frame bar 52. The two cover arms 54 each have a respective pair of inner and outer walls each with three semicircular notches 56 and the two frame arms 70 have a respective pair of inner and outer walls each with three semicircular notches 58. Upon placing the cover piece 50 onto the frame bar 52 and two frame arms 70, the three semicircular notches 56 in the inner and outer walls of the cover arms 70 align with the three semicircular notches 58 in the inner and outer walls of the two frame arms 70 to form four sets of three circular openings. The three circular openings for each set align with each other.

Three cylindrical rods 14, 16, 18 are fitted into respective ones of the four sets that form the three circular openings in alignment with each other. The three cylindrical rods 14, 16, 18 are rotatable within the circular openings. The cylindrical rods 14, 18 may be contiguous with the rollers 10, 12 respectively and contiguous with a pair of lead end gears 62 and a pair of trailing end gears 64 respectively. The cylindrical rod 16 may be contiguous with a pair of counter gears 60.

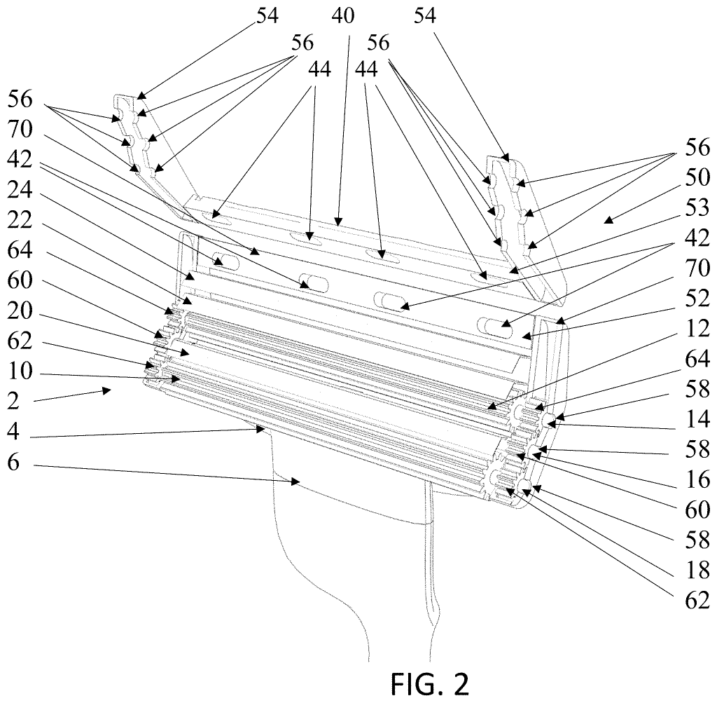

With reference to FIG. 2, a gear mechanism is provided that includes the pair of lead end gears 62, the pair of trailing end gears 64 and the pair of counter gears 60. The lead roller 10 and the pair of lead end gears 62 are rotatable in unison with and concentric with the cylindrical rod 18. The lead roller 10 spaces apart the pair of lead end gears 62 from each other and is spaced away from each. Also, the trailing roller 12 and the pair of two trailing end gears 64 are rotatable in unison with and concentric with the cylindrical rod 14. The trailing roller 12 spaces apart the pair of trailing end gears from each other and is spaced away from each. Further, the pair of counter gears 60 are rotatable in unison with and concentric with the cylindrical rod 16 and whose teeth engage in a meshing manner with teeth of the lead end gears 62 and the trailing end gears 64.

The inner and outer walls of the cover arms 54, together with similar walls of the frame arms 70 on both sides of the razor cartridge 2, cooperate to form two shield compartments that each accommodate a set of the two gears 62, 64 and the counter gear 60 and they block the entry of cut hair, skin and cream from reaching the gears 60, 62, 64. Access openings 72 are provided in the underside of each of the pair of frames 70 (on opposite sides of the razor cartridge 2) to enable cleaning of the gears 60, 62, 64 that are positioned above the access openings 72. The frame bar 52 extends between and is connected to the lower half of the two shield compartments and the cover bar 53 extends between and is connected to the upper half of the two shield compartments.

The counter gear 60 has the same gear ratio as the other two gears 62, 64, which likewise have the same gear ratio with each other. This lead roller 10 is responsible for starting the clearing process. The purpose of the counter gear 60 is to rotate the trailing roller 12 in the same direction as the lead roller 10. As a consequence, the trailing second gear 64 directly drives the trailing roller 12, which rotates in the same direction as the lead roller 10, moving debris from the front of the blade to the back. The rotation of the lead roller 10 drives the leading first gear 62 to rotate.

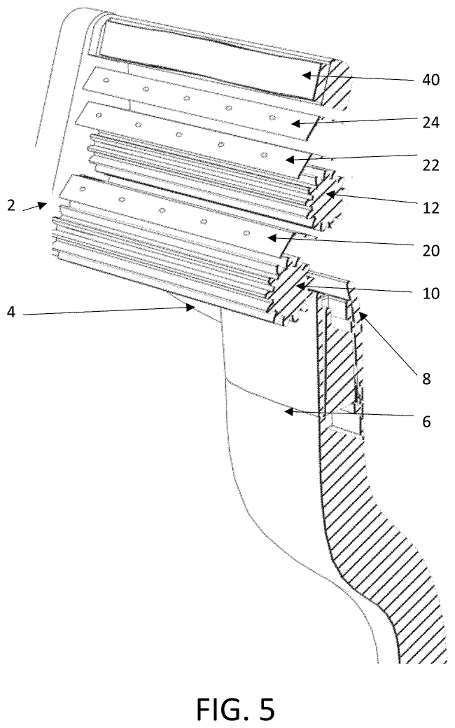

Turning to FIG. 5, an optional shield 8 may be provided that is supported by the handle 6, which also supports the razor cartridge 2 via two winged portions 4. The shield 8 is positioned between the lead roller 10 and the lead blade 20 in close proximity (or engagement with) the lead roller 10. The lead roller 10 carries away the cut hair, skin and cream effortlessly from the lead blade 20 during its rotation. Even so, any residual cut hair, skin and cream that remains on the lead roller 10 when the lead roller 10 rotates back into the space between the lead roller 10 and the lead blade 20, the optional shield 8 helps block the residual cut hair, skin and cream from reentering further into the space where it might accumulate. The rollers 10, 12 and the central portion of the cylindrical rods 20, 24 may be contiguously formed with each other.

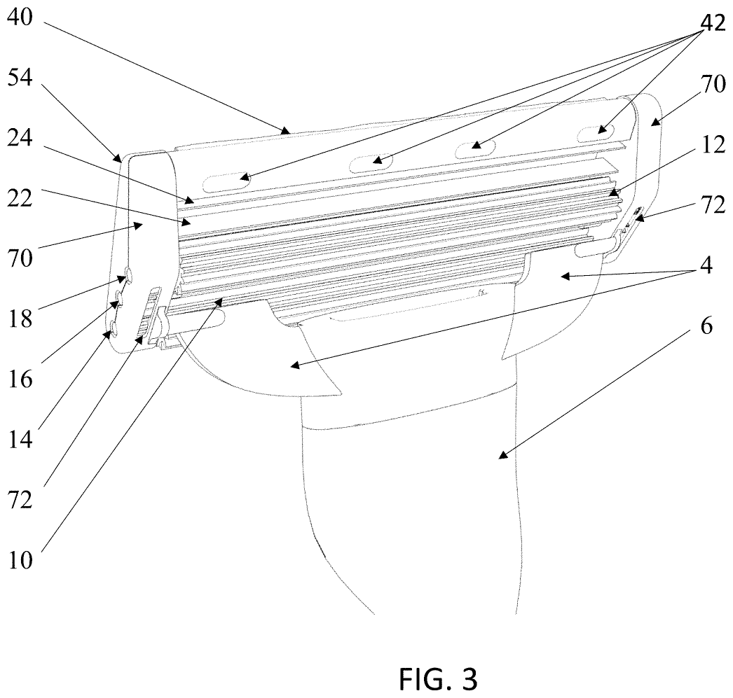

The wings 4 of FIGS. 1-4 may extend from the optional shield 8 of FIG. 5 to a cross-bar (not shown) that extends across the underside of the razor cartridge 2 between the pair of frames 70 of FIG. 3. The optional shield 8, cross-bar and pair of frames 70 may be contiguous with each other of unified construction such as with conventional injection molding techniques. Indeed, the rollers 10, 12 and gears 60, 62, 64 and their shafts may all be injected molded pursuant to conventional injection molding techniques. The plastic resin used to form such injection molded components of the invention are typically polystyrene, polypropylene, or phenyleneozide. The injection pressure is up to 16,000 psi for 5 seconds at 346 to 500 degrees Fahrenheit.

The spacing between the neighboring razor blades 20, 22 and the rollers 10, 12 approximates the same spacing that separates razor blades in a razor cartridge of conventional manual safety razors.

Water is used to clean the rollers 10, 12. The rollers 10, 12 allow the water discharged under a conventional sink faucet of a residence to rotate them and move material away from the blade. The self-cleaning aspect of the invention refers to self-cleaning the blade because of the roller rotation.

The razor blades 20, 22, 24 are of conventional manufacture, preferably metallic such as stainless steel with a sharpened edge at one end. The opposite end of the blade is preferably blunt and thus not sharpened.

While the foregoing description and drawings represent the preferred embodiments of the present invention, various changes and modifications may be made without departing from the scope of the present invention.

1: A self-cleaning razor cartridge, comprising:
two cutting blades that include a leading cutting blade and a trailing cutting blade;
two rollers that include a leading roller and a trailing roller, the two cutting blades and the two rollers being arranged in an alternating manner with respect to each other in a spaced apart relation, the two cutting blades each having a sharpened edge and having a lengthwise bend between two portions, one of the two portions of the leading cutting blade extending over the leading roller, the other of the respective two portions of the leading cutting blade extending into a space between the two rollers, one of the two portions of the trailing cutting blade extending over the trailing roller;
two shield compartments spaced apart from each other, the two cutting blades and the two rollers extending between the two shield compartments; and
a further cutting blade spaced from the trailing cutting blade, the further cutting blade being further away from the trailing roller than is the trailing cutting blade, the further cutting blade having a further sharpened edge and having a further bend between a further two portions, one of the further two portions extending over the trailing cutting blade, the other of the respective two portions of the trailing cutting blade extending into a space between the trailing roller and the further cutting blade, the further blade extending between the two shield compartments.

2. (canceled)

3: The self-cleaning razor cartridge of claim 2, further comprising:
a moisturizing strip arranged further away from the trailing cutting blade than the further cutting blade.

4-10. (canceled)

11: The self-cleaning razor cartridge of claim 1, further comprising:
at least two shafts concentric with respective ones of the two rollers and whose end regions are supported by the two shield compartments.
